(19) United States
(12) Patent Application Publication
(10) Pub. No.: US 2009/0126300 A1
(43) Pub. Date: May 21, 2009

(54) Interior-Finishing Material, and Method and Material for Coating the Same

(76) Inventors: Misuo Fujiwara, Osaka (JP); Katsunori Kubota, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/084,135

(22) PCT Filed: Oct. 26, 2005
(86) PCT No.: PCT/JP2005/019721

§ 371 Date: Jul. 1, 2008

(51) Int. Cl. E04F 13/18; E04B 1/92; E04B 1/62; B05D 3/00; E04C 2/26; E04B 2/72

(52) U.S. Cl. 52/309.13; 52/515; 427/397.7; 502/240; 502/80; 502/242; 502/243; 502/244

(57) ABSTRACT

After newly attaching an interior-finishing vinyl wall covering onto at least one of a wall, floor and ceiling of a building, or after completion of washing/renovation of the vinyl wall covering, a liquid or slurry coating material containing a titanium oxide, a layered silicate mineral, and a silver ion and/or a copper ion, is sprayed or applied onto a surface of the vinyl wall covering. Subsequently the coating material is naturally dried to form a thin transparent coating layer. In a process of renovating the vinyl wall covering, the coating layer is removed by washing with water or wiping with water to completely remove various stains. The present invention makes it possible to allow any worker, i.e., even an unskilled worker, to fully renovate an interior-finishing material, such as a vinyl wall covering, without difficulty and at low cost.

### TECHNICAL FIELD

The present invention relates to an interior-finishing material designed to be attached onto at least one of a wall, floor and ceiling of a building, and a method and a material for coating the interior-finishing material.

### BACKGROUND ART

Generally, a wall, floor or ceiling of a building is interiorly finished using an interior-finishing material. As such an interior-finishing material, an interior-finishing vinyl wall covering (hereinafter referred to as “vinyl wall covering”) made, for example, of vinyl chloride, is widely used, in view of high flexibility in artistic design and easiness in interior finish work. However, the vinyl wall covering will be gradually stained over time by cigarette smoke, graffiti, oily smoke, growth of mold and others. Thus, when the stain becomes marked, the wall, floor or ceiling is usually refurbished. Heretofore, the refurbishment has been typically performed in such a manner that the stained vinyl wall covering is peeled and replaced with a new vinyl wall covering.

In case of replacing a vinyl wall covering in this manner, it is required to take a lot of time for replacement work. Moreover, the replacement work is extremely costly. Specifically, it is necessary to cover a cost for purchasing a new vinyl wall covering, a cost for peeling an old vinyl wall covering and attaching a new vinyl wall covering, and a cost for discarding the peeled vinyl wall covering. Therefore, there have been proposed various vinyl wall covering (or interior-finishing material) renovating techniques for recovering an aesthetic appearance of a vinyl wall covering without replacing the vinyl wall covering with a new one (see, for example, the following Patent Publication 1).

[Patent Publication 1] JP 2000-176390 A

### DISCLOSURE OF THE INVENTION

### Problem to be Solved by the Invention

Specifically, for instance, the following interior-finishing material renovating techniques (methods) have been known:

(1) A technique of bleach-cleaning a surface of a vinyl wall covering, using chlorine-based and/or oxygen-based agents (bleach/reduction cleaning method). This renovating method causes deterioration in work environment;

(2) A technique of washing a surface of a vinyl wall covering, and then applying an emulsion-based paint or the like onto the surface, using a roller or the like (paint-based cloth wash);

(3) A technique of washing a surface of a vinyl wall covering, and then spraying an emulsion-based paint or the like onto the surface, using a jet nozzle or the like (paint-based Y'S Corporation); and

(4) A technique using an “AARAERU KUROSU®” which is an easily-washable cloth having a surface coated with a vinyl coating. This vinyl coating is more likely to attract dust particles and thereby become stained.

The above conventional renovating techniques (methods) have problems about complication in renovation work or operation, and increase in cost. Moreover, it involves a problem about considerable difficulty in completely removing various stains, such as a carbon mark due to a refrigerator, tar of cigarettes, graffiti using a crayon, ink of a felt pen, and oil spots. Even if the stains can be completely removed, it is required to spend a lot of time and effort.

A vinyl wall covering (or interior-finishing material) renovating method disclosed in the Patent Publication 1 is designed such that a cleaning liquid or a stain remover liquid is sprayed onto a vinyl wall covering to recover an aesthetic appearance of the vinyl wall covering, wherein an advanced or sophisticated technique is used for cleaning the vinyl wall covering (or interior-finishing material). Thus, this renovating method has a problem that a skilled worker is essential for renovation work, or it is necessary to promote thoughtful education for allowing a worker to learn the sophisticated technique.

In view of solving the above conventional problems, it is an object of the present invention to provide means capable of allowing any worker, i.e., even an unskilled worker, to fully (adequately) renovate an interior-finishing material, such as a vinyl wall covering, without difficulty and at low cost.

### Means for Solving the Problem

In order to achieve the above object, according a first aspect of the present invention, there is provided a method of coating an interior-finishing material (e.g., vinyl wall covering) attached on at least one of a wall, floor and ceiling of a building. This first method comprises: after newly attaching the interior-finishing material onto at least one of the wall, floor and ceiling, or after completion of renovation (or washing) of the interior-finishing material attached on at least one of the wall, floor and ceiling, spraying or applying a liquid or slurry coating material which contains a photocatalytic substance (e.g., titanium oxide) exhibiting a photocatalytic action, and a layered silicate mineral (e.g., one selected from the group consisting of water-swellable clay mineral, saponite, hectorite, bentorite, montmorillonite, smectite, vermiculite, mica-based layered silicate mineral, kaolin-based layered silicate mineral, and talc-based layered silicate mineral), onto a surface of the interior-finishing material; and subsequently drying (e.g., naturally drying) the coating material to form a thin (substantially transparent) coating layer on the surface of the interior-finishing material.

In the first method of the present invention, the coating material is sprayed or applied preferably in an amount of 140 to 160 g/m² (more preferably in an amount of about 150 g/m²). Preferably, the coating material contains a silver ion and/or a copper ion. The coating material may contain silica. Preferably, each of one or more (or all) primary components including the photocatalytic substance, the layered silicate mineral, a substance containing a copper or silver ion, and silica, is used in the form of nanosized particles obtained through an inter-particle frictional crushing process (nanotechnology).

According to a second aspect of the present invention, there is provided a coating material for an interior-finishing material (e.g., vinyl wall covering) attached on at least one of a wall, floor and ceiling of a building. This coating material comprises a photocatalytic substance (e.g., titanium oxide) exhibiting a photocatalytic action, and a layered silicate mineral (e.g., one selected from the group consisting of water-swellable clay mineral, saponite, hectorite, bentorite, montmorillonite, smectite, vermiculite, mica-based layered silicate mineral, kaolin-based layered silicate mineral, and talc-based layered silicate mineral). Preferably, the coating material of the present invention contains a silver ion and/or a copper ion. The coating material may contain silica. Preferably, each of one or more primary components including the photocatalytic substance, the layered silicate mineral, a substance containing a copper or silver ion, and silica, is used in the form of nanosized particles obtained through an inter-particle frictional crushing process.

According to a third aspect of the present invention, there is provided an interior-finishing material (e.g., vinyl wall covering) which comprises a thin coating layer formed on a surface thereof, wherein the coating layer contains a photocatalytic substance (e.g., titanium oxide) exhibiting a photocatalytic action, and a layered silicate mineral (e.g., one selected from the group consisting of water-swellable clay mineral, saponite, hectorite, bentorite, montmorillonite, smectite, vermiculite, mica-based layered silicate mineral, kaolin-based layered silicate mineral, and talc-based layered silicate mineral). In the interior-finishing material of the present invention, the coating material preferably contains a silver ion and/or a copper ion. The coating material may contain silica. Preferably, each of one or more (or all) primary components including the photocatalytic substance, the layered silicate mineral, a substance containing a copper or silver ion, and silica, is used in the form of nanosized particles obtained through an inter-particle frictional crushing process.

According to a fourth aspect of the present invention, there is provided a method of coating an interior-finishing material attached on at least one of a wall, floor and ceiling of a building. This second method comprises: after attaching the interior-finishing material onto at least one of the wall, floor and ceiling, or after completion of renovation of the interior-finishing material attached on at least one of the wall, floor and ceiling, spraying or applying a liquid or slurry coating material which contains a layered silicate mineral, onto a surface of the interior-finishing material; and subsequently drying the coating material to form a thin coating layer on the surface of the interior-finishing material. That is, except that the photocatalytic substance is not used, the second method is identical to the first method.

### ADVANTAGES OF THE INVENTION

According to the interior-finishing material, or the method or material for coating the interior-finishing material, in a process of renovating the interior-finishing material, such as a vinyl wall covering, stains attaching on a surface the interior-finishing material can be completely removed by a significantly simple operation, for example, of simply washing or wiping the surface the interior-finishing material with water or regular detergent. This allows any worker, i.e., even an unskilled worker, to fully (adequately) renovate the interior-finishing material, such as a vinyl wall covering, without difficulty and at low cost. In addition, the coating material has a humidity conditioning capability to provide enhanced indoor environment.

### BRIEF DESCRIPTION OF DRAWINGS

FIG. 1 is a flowchart showing one example of a vinyl wall covering renovating process based on a coating method or a coating material of the present invention.

FIG. 2 is a graph showing a temporal change in formaldehyde concentration.

FIG. 3 is a graph showing a temporal change in acetaldehyde concentration.

FIG. 4 is a graph showing a temporal change in ammonia concentration.

FIG. 5 is a graph showing a temporal change in xylene concentration.

### EXPLANATION OF CODES

S1: vinyl wall covering attaching step
S2: coating-material spraying/applying step
S3: drying step
S4: vinyl wall covering renovating step

### BEST MODE FOR CARRYING OUT THE INVENTION

With reference to the accompanying drawings, an embodiment of the present invention will now be specifically described.

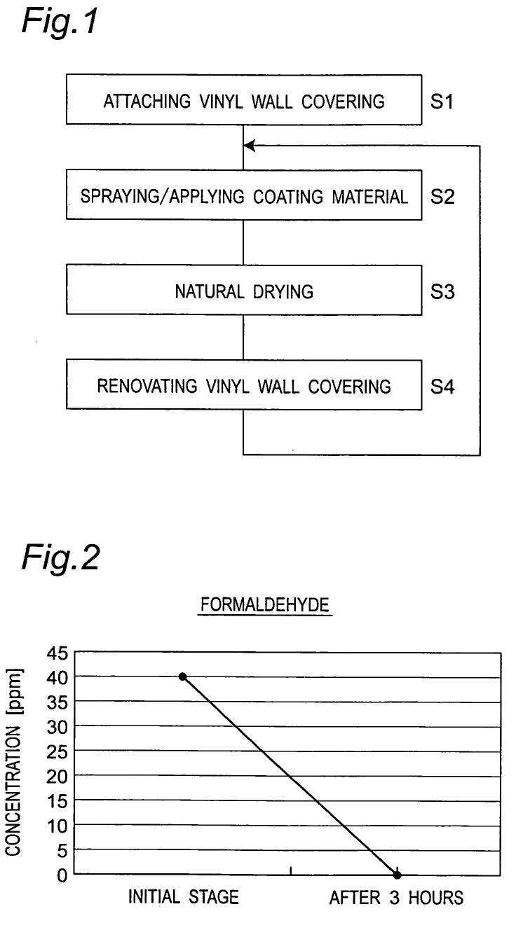

FIG. 1 is a flowchart showing one example of a process of renovating a vinyl wall covering attached to at least one of a wall, floor and a ceiling of a building (hereinafter referred to as “interior surface”, based on a coating method or a coating material of the present invention. As shown in FIG. 1, in this vinyl wall covering renovating process, when a vinyl wall covering is newly attached onto an interior surface of a building during new construction or refurbishment of the building (Step S1), the coating material is sprayed onto an entire surface of the vinyl wall covering using a spray gun or the like, or applied onto the entire surface of the vinyl wall covering using a roller, a brush, a spatula, a trowel or the like (Step S2).

The building is not limited to a specific type, but may be any type, such as a private or rental single-unit housing, a complex housing (such as a condominium), or an office or store in a building. The vinyl wall covering is a type having a highly aesthetic appearance with various colors and patterns. The vinyl wall covering may be a type having a patterned indented surface subjected to an embossing or foaming process.

Basically, the coating material is a liquid or slurry (or paste) type prepared by mixing a titanium oxide which is one photocatalytic substance exhibiting a photocatalytic action, and a layered silicate mineral (e.g., one selected from the group consisting of water-swellable clay mineral, saponite, hectorite, bentorite, montmorillonite, smectite, vermiculite, mica-based layered silicate mineral, kaolin-based layered silicate mineral, and talc-based layered silicate mineral), with water. If required, at least one of a silver ion, a copper ion and silica, may be added to the coating material, depending on properties of the vinyl wall covering or the like. Each of the titanium oxide and the layered silicate mineral is used in the form of nanosized particles obtained through an inter-particle frictional crushing process (nanotechnology). In case of adding at least one of a silver ion, a copper ion and silica, each of a substance containing a silver or copper ion, and silica, is also used in the form of nanosized particles obtained through an inter-particle frictional crushing process. This coating material is odorless, because it consists of an inorganic substance and water. In addition, the coating material is nonflammable, and therefore extremely safe. The coating material is sprayed or applied preferably in an amount of 140 to 160 g/m², more preferably in an amount of about 150 g/m². Even if the coating material is sprayed or applied with a substantial unevenness, such an unevenness becomes completely invisible or unrecognizable after drying, because a coating layer formed from the coating material is substantially transparent, as will be described later. Thus, any worker, i.e., even an unskilled worker, can complete an operation in the Step S2 without difficulty within a short period of time.

Then, the coating material sprayed or applied onto the surface of the vinyl wall covering is dried by natural drying (Step S3). During the drying, only water contained in the coating material vaporizes, and any substance having an adverse environmental effect is not released from the coating material. Through the drying, a coating layer is formed on the surface of the vinyl wall covering. This coating layer is unlikely to attract (absorb) dust particles and to be changed in color and stained, so that an esthetic or aesthetic appearance of the vinyl wall covering is maintained over a long period of time. In addition, the coating layer is harmless to humans, and therefore a safety problem never occurs even if an infant or a young child touches the coating layer.

The coating layer is significantly thin and substantially transparent to allow the esthetic or aesthetic appearance of the vinyl wall covering to be directly reflected. In addition, the coating layer (clay layer) containing a layered silicate mineral and a titanium oxide as a primary component is not changed in shape and properties even after an elapse of a substantial time. Further, the coating layer is a clayey material with a layered structure. Thus, for example, even if the coating layer is scrabbled using a crayon or a felt pen, the crayon or felt pen is more likely to slip thereon, and thereby the graffiti is precluded from being deeply written in the coating layer. In a vinyl wall covering having an embossed pattern in a surface thereof, fine clayey particles in the coating layer are trapped into the embossed pattern to prevent stains from getting into the embossed pattern.

The titanium oxide (TiO₂) contained in the coating layer is a metal-oxide semiconductor material having a photocatalytic action. Thus, in a state after the coating layer is formed on the surface of the vinyl wall covering newly attached on the interior surface, the titanium oxide can effectively decompose an environmental pollutant or a malodorous substance released from the vinyl wall covering, such as formaldehyde, based on the photocatalytic action.

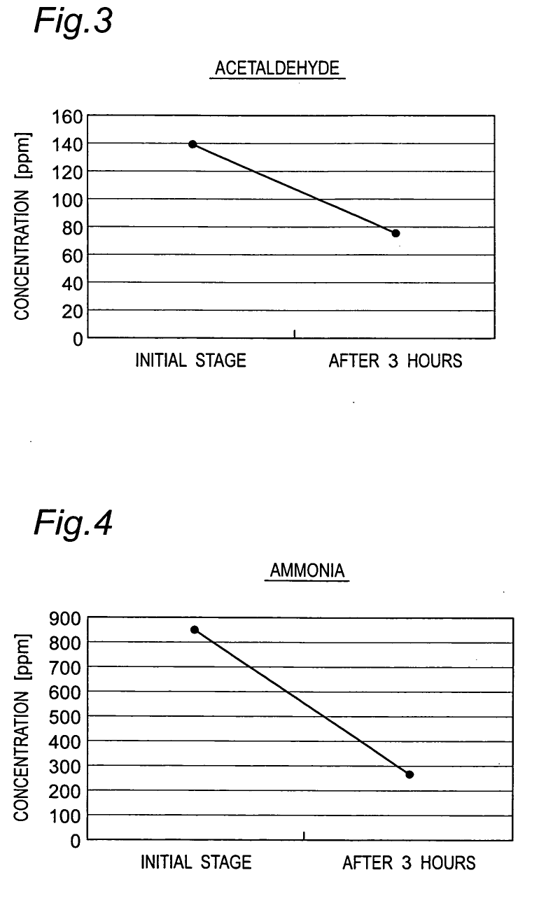

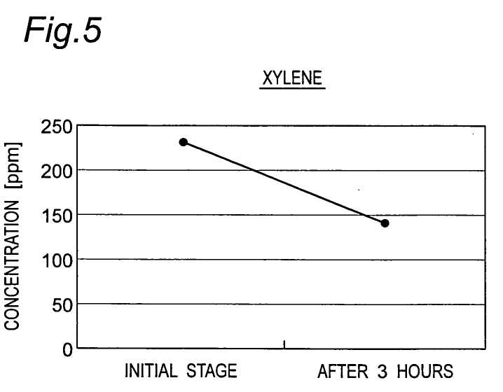

FIGS. 2 to 5 show results obtained by actually measuring respective abilities of the coating layer according to the present invention to decompose formaldehyde, acetaldehyde, ammonia and xylene. This measurement was performed as follows. After a container having an inner volume of 5 L was filled with air containing formaldehyde, acetaldehyde, ammonia or xylene in a given concentration, a vinyl wall covering having an unfolded surface formed in a square shape of 100 mm×100 mm and provided with the coating layer according to the present invention was put in the container. Then, after an elapse of 3 hours, a concentration of formaldehyde, acetaldehyde, ammonia or xylene was detected by a detector tube. On an assumption of a typical indoor brightness, an internal space of the container was irradiated with light of a fluorescent lamp at an intensity of 200 lx.

As seen in FIGS. 2 to 5, after the elapse of 3 hours, the concentration of formaldehyde, acetaldehyde, ammonia or xylene is drastically lowered. From the results, it is proven that the coating layer according to the present invention can effectively decompose an environmental pollutant or a malodorous substance released from the vinyl wall covering, such as formaldehyde, based on the photocatalytic action of the titanium oxide.

Based on the photocatalytic action, the titanium oxide can also decompose fine stains attaching on the coating layer or the vinyl wall covering to suppress deterioration in the esthetic or aesthetic appearance of the vinyl wall covering.

Subsequently, the vinyl wall covering will be gradually stained over time. Then, when the stain becomes marked, the vinyl wall covering is renovated (Step S4). In cases where the building is a lease type, a vinyl wall covering is generally renovated when a lessor cancels the lease, even if the vinyl wall covering has only a minor stain.

In a process of renovating the vinyl wall covering, the surface of the vinyl wall covering is firstly washed. This washing may be performed simply using only water, or may be performed using conventional regular detergent according to need. Although the coating layer is formed on the surface of the vinyl wall covering, as mentioned above, most of various stains simply attach on the surface of the coating layer or penetrate into the coating layer, almost without attaching on the vinyl wall covering. That is, the coating layer protects the vinyl wall covering from stains.

Further, the coating layer contains the layered silicate mineral as a primary component. This makes it possible to readily remove the coating layer by washing with water. Thus, the coating layer can be removed by simple washing with water or washing with water and regular detergent, to substantially completely remove various stains attaching on the coating layer or the vinyl wall covering, such as a carbon mark due to a refrigerator, tar of cigarettes, graffiti using a crayon, ink of a felt pen, and oil spots, which have otherwise been hardly removed.

That is, in the washing step, a worker can focus on removing the layered silicate mineral, because, if the layered silicate mineral is removed, almost all stains can be removed. Thus, any worker leaned a simple washing technique, i.e., even an unskilled worker, can perform the washing operation without difficulty and within a short period of time. Through the washing or renovation, the vinyl wall covering can substantially fully recover its original esthetic or aesthetic appearance.

The coating layer can also be removed simply by wiping with water. Thus, stains may be removed by wiping with water, instead of the washing.

For example, in a conventional vinyl wall covering, tar of cigarettes will penetrate into the vinyl wall covering over time. Differently, in the vinyl wall covering of the present invention, the layered silicate mineral contained in the coating layer prevents the penetration of tar of cigarettes into the vinyl wall covering to some extent, and the titanium oxide contained in coating layer decomposes the tar of cigarettes based on the photocatalytic action. Thus, even if an operation of renovating the vinyl wall covering is not performed over a long period of time, the vinyl wall covering has only a minor stain due to the tar of cigarettes. This stain due to the tar of cigarettes can be completely removed by washing during renovation of the vinyl wall covering. For example, in a lease housing, when a lessor cancels the lease, a stain due to tar of cigarettes is likely to cause a trouble about recovery of the current condition. The present invention can suppress the occurrence of such a trouble.

After the vinyl wall covering is washed or renovated in the above manner, the coating material is re-sprayed or re-applied onto the surface of the vinyl wall covering, and then dried to form the coating layer. This process of forming the coating layer is the same as that described in connection with the Steps S2 and S3. Subsequently, every time stains of the vinyl wall covering becomes marked, the process of washing or renovating the vinyl wall covering and forming the coating layer will be repeatedly performed. Even if the process of washing or renovating the vinyl wall covering and forming the coating layer is repeatedly performed substantial times, the esthetic or aesthetic appearance of the vinyl wall covering can be maintained, because the esthetic or aesthetic appearance is substantially fully recovered by the washing or renovation, as mentioned above. This makes it possible to drastically extend a durable period of the vinyl wall covering.

As mentioned above, a vinyl wall covering is one of the most popular interior-finishing materials, in view of high flexibility in artistic design and easiness in interior finish work. On the other hand, the conventional vinyl wall covering has many disadvantages such that: it is more likely to have a black stain or a stain due to tar of cigarettes; an adhesive used in the attaching operation induces sick house (or building) syndrome; and its organic component serves as a nutritive substance to promote propagation of mold. With a view to solving these disadvantages of the conventional vinyl wall covering, in the present invention, the coating material containing a layered silicate mineral which is a component of the earth, and a titanium oxide having a photocatalytic action, as a primary component, is sprayed or applied onto a vinyl wall covering, and then dried to form a thin transparent coating layer (protective coat or film). Thus, the present invention has the following advantages.

(1) The coating layer (protective film) formed on the surface of the vinyl wall covering can be removed by washing with water or wiping with water. Thus, stains, such as a black stain occurring behind an electric appliance and a stain due to tar of cigarettes, which have otherwise been hardly removed, can be readily removed together with the coating layer. Even if the coating layer is removed, such a coating layer can be readily re-formed (or repeatedly formed).

(2) A malodorous component and a solvent component contained in the vinyl wall covering can be strongly absorbed and decomposed by the layered silicate mineral, the photocatalytic substance and the metal ions contained in the coating layer. This is effective as deodorizing means or a measure against sick house (or building) syndrome.

(3) The titanium oxide (photocatalytic substance) and the metal ions contained in the coating layer can suppress propagation of microorganisms to obtain enhanced antimicrobial effect or enhanced antimold effect.

(4) The coating layer can hold off dust, based on its antistatic effect.

(5) The layered silicate mineral can absorb pollens and the titanium oxide (photocatalytic substance) can decompose the pollens to suppress pollen allergy.

(6) The coating material has a humidity conditioning capability, and therefore provide enhanced indoor environment.

In the coating material for the interior-finishing material of the present invention, the primary component is formed as nanosized particles by an inter-particle frictional crushing process (nanotechnology) This makes it possible to facilitate reduction in amount of the coating material and allow even an extremely small (ultra-small) dent in the interior-finishing material to be coated with the coating material. The photocatalytic effect of the titanium oxide can be brought out only by a small amount of light.

In this embodiment, a vinyl wall covering is used as the interior-finishing material, in view of high flexibility in artistic design and easiness in interior finish work. It is understood that the coating method of the present invention may be applied to various interior-finishing cloths other than the vinyl wall covering, such as a ceiling noise-absorbing material, a fabric cloth, and a board (e.g., gypsum board). While the layered silicate mineral is used in this embodiment, any other suitable clay may also be used.

In this embodiment, the liquid or slurry material prepared by mixing the photocatalytic substance and the layered silicate mineral, with water, is used as the coating material. Alternatively, the coating material may be devoid of the photocatalytic substance. In this case, except that the photocatalytic effect cannot be obtained, the same advantages as those in the above embodiment can be obtained. Such a coating material, and a method of coating an interior-finishing material using the coating material, also fall within the scope of the present invention.

While the present invention has been described in conjunction with a specific embodiment thereof, various changes and modifications will become apparent to those skilled in the art. Therefore, it is intended that the present invention is not limited to the illustrative embodiment herein, but only by the appended claims and their equivalents.

### INDUSTRIAL APPLICABILITY

As above, the interior-finishing material, and the method and material for coating the interior-finishing material, of the present invention, is useful particularly in an interior finish work for a building, and capable of allowing any worker, i.e., even an unskilled worker, to effectively renovate an interior-finishing material, such as a vinyl wall covering, without difficulty and at low cost.

1. A method of coating an interior-finishing material attached on at least one of a wall, floor and ceiling of a building, said method comprising:
after attaching the interior-finishing material onto at least one of the wall, floor and ceiling, or after completion of renovation of the interior-finishing material attached on at least one of the wall, floor and ceiling, spraying or applying a liquid or slurry coating material which contains a photocatalytic substance exhibiting a photocatalytic action, and a layered silicate mineral, onto a surface of the interior-finishing material; and
subsequently drying the coating material to form a thin coating layer on the surface of the interior-finishing material.

2. The method as defined in claim 1, wherein each of said photocatalytic substance and said layered silicate mineral is used in the form of nanosized particles obtained through an inter-particle frictional crushing process.

3. The method as defined in claim 1, wherein said layered silicate mineral is a water-swellable clay mineral.

4. The method as defined in claim 1, wherein said layered silicate mineral is one selected from the group consisting of saponite, hectorite, bentorite, montmorillonite, smectite, vermiculite, mica-based layered silicate mineral, kaolin-based layered silicate mineral, and talc-based layered silicate mineral.

5. The method as defined in claim 1, wherein said photocatalytic substance is a titanium oxide.

6. The method as defined in claim 1, wherein said coating material contains a silver ion and/or a copper ion.

7. The method as defined in claim 6, wherein said coating material contains silica.

8. The method as defined in claim 1, wherein said coating material is sprayed or applied in an amount of 140 to 160 g/m².

9. The method as defined in claim 1, wherein said coating material is dried by natural drying.

10. The method as defined in claim 1 wherein said interior-finishing material is a vinyl wall covering.

11. A coating material for an interior-finishing material attached on at least one of a wall, floor and ceiling of a building, said coating material comprising a photocatalytic substance exhibiting a photocatalytic action, and a layered silicate mineral.

12. The coating material as defined in claim 11, wherein each of said photocatalytic substance and said layered silicate mineral is in the form of nanosized particles obtained through an inter-particle frictional crushing process.

13. The coating material as defined in claim 11, wherein said layered silicate mineral is a water-swellable clay mineral.

14. The coating material as defined in claim 11, wherein said layered silicate mineral is one selected from the group consisting of saponite, hectorite, bentorite, montmorillonite, smectite, vermiculite, mica-based layered silicate mineral, kaolin-based layered silicate mineral, and talc-based layered silicate mineral.

15. The coating material as defined in claim 11, wherein said photocatalytic substance is a titanium oxide.

16. The coating material as defined in claim 11, which contains a silver ion and/or a copper ion.

17. The coating material as defined in claim 16, which contains silica.

18. An interior-finishing material comprising a thin coating layer formed on a surface thereof, said coating layer containing a photocatalytic substance exhibiting a photocatalytic action, and a layered silicate mineral.

19. The interior-finishing material as defined in claim 18, wherein each of said photocatalytic substance and said layered silicate mineral is in the form of nanosized particles obtained through an inter-particle frictional crushing process.

20. The interior-finishing material as defined in claim 18, wherein said layered silicate mineral is a water-swellable clay mineral.

21. The interior-finishing material as defined in claim 18, wherein said layered silicate mineral is one selected from the group consisting of saponite, hectorite, bentorite, montmorillonite, smectite, vermiculite, mica-based layered silicate mineral, kaolin-based layered silicate mineral, and talc-based layered silicate mineral.

22. The interior-finishing material as defined in claim 18, wherein said photocatalytic substance is a titanium oxide.

23. The interior-finishing material as defined in claim 18, wherein said coating material contains a silver ion and/or a copper ion.

24. The interior-finishing material as defined in claim 23, wherein said coating material contains silica.

25. The interior-finishing material as defined in claim 18, which is a vinyl wall covering.

26. A method of coating an interior-finishing material attached on at least one of a wall, floor and ceiling of a building, said method comprising:
after attaching the interior-finishing material onto at least one of the wall, floor and ceiling, or after completion of renovation of the interior-finishing material attached on at least one of the wall, floor and ceiling, spraying or applying a liquid or slurry coating material which contains a layered silicate mineral, onto a surface of the interior-finishing material; and
subsequently drying the coating material to form a thin coating layer on the surface of the interior-finishing material.

27. The method as defined in claim 26, wherein said layered silicate mineral is used in the form of nanosized particles obtained through an inter-particle frictional crushing process.

28. The method as defined in claim 26, wherein said layered silicate mineral is a water-swellable clay mineral.

29. The method as defined in claim 26, wherein said layered silicate mineral is one selected from the group consisting of saponite, hectorite, bentorite, montmorillonite, smectite, vermiculite, mica-based layered silicate mineral, kaolin-based layered silicate mineral, and talc-based layered silicate mineral.

30. The method as defined in claim 26, wherein said coating material contains silica.

31. The method as defined in claim 30, wherein said silica is used in the form of nanosized particles obtained through an inter-particle frictional crushing process.

32. The method as defined in claim 26, wherein said coating material contains a silver ion and/or a copper ion.
